(19) United States
(12) Patent Application Publication
(10) Pub. No.: US 2009/0139282 A1
(43) Pub. Date: Jun. 4, 2009

(54) Dial lock for luggage

(75) Inventor: Tomohiro Yoshida, Tokyo (JP)

Correspondence Address: RABIN & Berdo, PC, 1101 14TH STREET, NW, SUITE 500, WASHINGTON, DC, 20005, US

(73) Assignee: KABUSHIKI KAISHA HINOMOTO JOMAE

(21) Appl. No.: 10/591,710

(22) PCT Filed: Mar. 28, 2006
(86) PCT No.: PCT/JP06/06209

§ 371 Date: Sep. 6, 2006

(51) Int. Cl. E05B 65/52

(52) U.S. Cl. 70/71

(57) ABSTRACT

To unlock and re-rock a dial lock for a traveling bag for inspection, a center lock 6 of the bag includes an ordinary dial lock 20 having dials 21, and an operation part 50 operated with a master key by only an inspector, a bolt of the dial lock has a pressing part, which is pressed by the master key inserted into a key hole 52 of a key hole plate 51 of the operation part 50 to make the dial lock in an unlocking state, the key hole plate 51 rotated together with the key is formed in an oval-like shape obtained by cutting off both sides of a disk so that a colored part 54 of a front plate 53 appears in the cut off part of the key hole plate when the key is rotated to the unlocking state, thereby preventing failure of re-locking.

This is a nationalization of PCT/JP2006/306209 filed Mar. 28, 2006.

### BACKGROUND OF THE INVENTION

1. Field of the Invention

The present invention relates to a dial lock for a luggage which can be readily opened for an inspection of a traveling bag presently performed in an airport in the U.S.

2. Description of the Conventional Art

A dial lock, which is locked and unlocked by rotating dials, has been mainly used for a traveling bag. (for example, refer to Japanese patent Application Laid Open No. 2004-100323)

Recently, each country have strengthened security at an airport with respect to terrorism occurring frequently. In the U.S. especially, in order to inspect an explosive, an inspector of the U.S. transportation security office is empowered to open a luggage, when a suspicious object seems to be contained therein by an inspection with a X-ray or the like, and inspect a content of the luggage without attendance of a passenger in all airports in the U.S. since January, 2003.

Thus, a passenger is directed to keep unlocked a lock of a luggage such as a traveling bag or the like at a check-in counter. When an inspector wants to inspect the luggage, the inspector has an authority to break a lock and inspect, if the luggage remains locked.

However, a passenger worries about that a luggage which is not locked may open by accident or content may be stolen. Therefore, there is a request that the luggage should desirously be locked except the time of the inspection.

### SUMMARY OF THE INVENTION

As described above, the traveling bag or the like which is used when using an airport in the U.S. must have a function that, while a lock can be normally locked and unlocked at an usual time, the locked lock can be unlocked by only an authorized inspector of the transportation security office, if necessary, and can be re-locked after the inspection.

According to an aspect of the present invention, to solve the above-described problems, a dial lock for a luggage has a means for rotating a bolt between a locking position and unlocking position of a lock, in addition to an ordinary function of the dial lock.

The lock is produced by a maker side corresponding to a master key, which is to be decided and used by the U.S. transportation security office, and is to be mounted to each luggage after being authorized by the office. A passenger having a luggage provided with the lock of the present invention can check-in the luggage at a check-in counter in the state that the lock is locked. If an inspection is necessary, an inspector can open the locked luggage with a master key, and can re-lock it after the inspection.

However, if the inspector forgets locking after the inspection, the luggage may be transported to a destination airport without being locked.

In order to prevent this problem, according to the present invention, a rotary key hole plate having a key hole of a master key is formed to have an oval-like shape obtained by cutting off both sides of a disk shape. A plate on the luggage side contacting with the key hole plate is colored into a conspicuous color corresponding to the shape of the key hole plate. When an inspector rotates a master key to the unlocking position of the lock, the conspicuous color is seen in cut off portions at the both sides of the key hole plate, and when the inspector rotates the key to the locking position, round portions of the key hole plate cover the colored portion. Thus, when the inspector closes the lid of the luggage after the inspection, he can see the color of the colored portion in the cut off portions at the both sides of the key hole plate, until re-locking. Thereby, the inspector can notice at a glance that the luggage is not re-locked, so that a risk to forget re-locking can be reduced.

The dial lock for a luggage of the present invention has the above-described structure. When the dial lock is approved by the U.S. transportation security office and used to a luggage, only an inspector in an airport in the U.S. can have a master key, and a passenger can check-in a locked luggage, and further, a risk that an inspector forgets re-locking after an inspection can be prevented.

### BRIEF EXPLANATION OF DRAWINGS

FIG. 1 is a front view of a traveling bag.

FIG. 2 is a front view illustrating a state of a center lock when it is locked.

FIG. 3 is an expanded front view of an operation part for a master key in FIG. 2.

FIG. 4 is a front view illustrating a state of a center lock when the lock is unlocked.

FIG. 5 is an expanded front view of an operation part for a master key in FIG. 4.

FIG. 6 is a plan view of a bolt of the present invention.

FIG. 7 is an end surface view when FIG. 6 is seen from the T direction.

FIG. 8 is a side surface view when FIG. 6 is seen from the S direction.

### DETAILED DESCRIPTION OF PREFERRED EMBODIMENT

In the present invention, in order to obtain an objective described above a driving part is additionally provided to a bolt of a normal dial lock, where the driving part can compulsorily rotate the bolt from the locking position to the unlocking position by a master key of an inspector.

In an airport, the inspector compulsorily rotates the bolt of the locked dial lock to the unlocking position by the master key at the time of inspection, and re-locks it after the inspection. Therefore, the dial lock is locked except the time of the inspection, and only the authorized inspector has the master key, so that a passenger can safely check-in the locked traveling bag at the check-in counter.

### Example

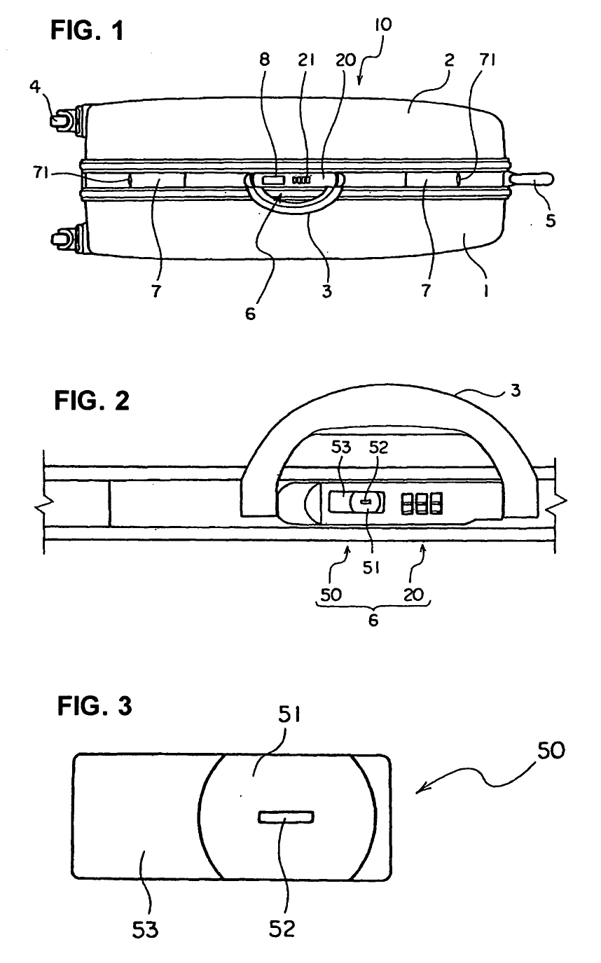

FIG. 1 illustrates a front view of a traveling bag 10 having a dial lock for a traveling bag according to the present invention. Reference code 1 denotes a traveling bag main body, reference code 2 denotes a lid, reference code 3 denotes a handle, reference code 4 denotes casters for moving, reference code 5 denotes a handle for moving, reference code 6 denotes a center lock including a normal dial lock 20 and an operation part 50, which is operated by the master key of the inspector, and reference code 7 denotes side locks for opening the lid 2. In addition, reference code 21 denotes dials of the dial lock, and reference code 71 denotes push levers of the side locks for opening the lid.

Further, the present invention has the following structure. A key hole plate is formed to have an oval-like shape obtained by cutting off both sides of a disk shape, where the key hole plate is rotated simultaneously by the operation of the master key. When the inspector unlocks the dial lock by the master key, colored portions appear at the cut off portions. Thus, it is clear that the dial lock is unlocked, so that a risk that the inspector forgets re-locking after the inspection can be prevented.

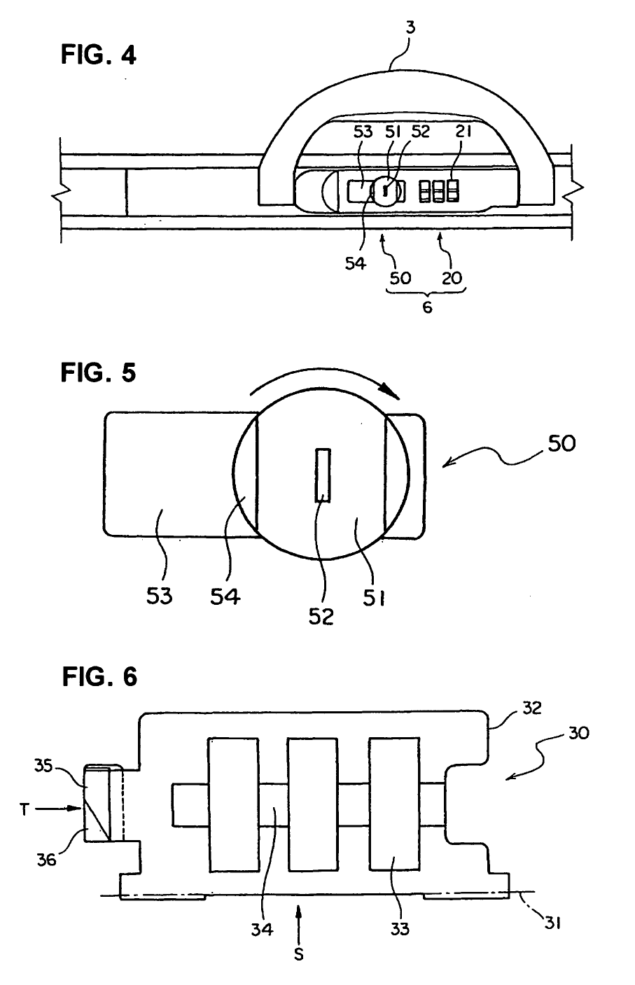

The above described structure of the present invention is clear from FIG. 2 to 5. FIGS. 2 and 4 are front views in which a center lock portion of the traveling bag 10 is shown, and FIGS. 3 and 5 are front views in which only an operation part, which is operated by the master key of the inspector, is enlarged and shown. FIGS. 2 and 3 illustrate a state in which a passenger locks the dial lock (including a case that the inspector re-locks it after the inspection), and FIGS. 4 and 5 illustrate a state in which the inspector unlocks the locked dial lock by the master key in order to inspect the traveling bag.

The center lock 6 includes the normal dial lock 20 and the operation part 50, which is operated by the master key. The operation part 50 operated by the master key has a key hole 52 for the master key, and a key hole plate 51, which is rotated together with the rotation of the key, is provided so as to contact to a front plate 53 for covering a front surface of the operation part 50. As clearly seen from the drawings, the key hole plate 51 is formed to have the oval-like shape obtained by cutting off both sides of the disk shape. Further, as illustrated in FIGS. 2 and 3, when the lock is locked by the master key, the key hole plate 51 and a part of the front plate 53 are overlapped exactly. However, as illustrated in FIGS. 4 and 5, when the lock is unlocked by rotating it 90 degrees by the key, the front plate corresponding to the cut off portion on the both sides of the key hole plate 51, appears to be seen. If a portion 54 of the front plate 53 corresponding to the cut off portion of the key hole plate 51 is colored into the conspicuous color, for example, a red color, it is clear at a glance from the outside that the lock is unlocked, when the lock is unlocked by the master key, as illustrated in FIGS. 4 and 5. Thus, a risk that the inspector forgets re-locking after the inspection can be prevented.

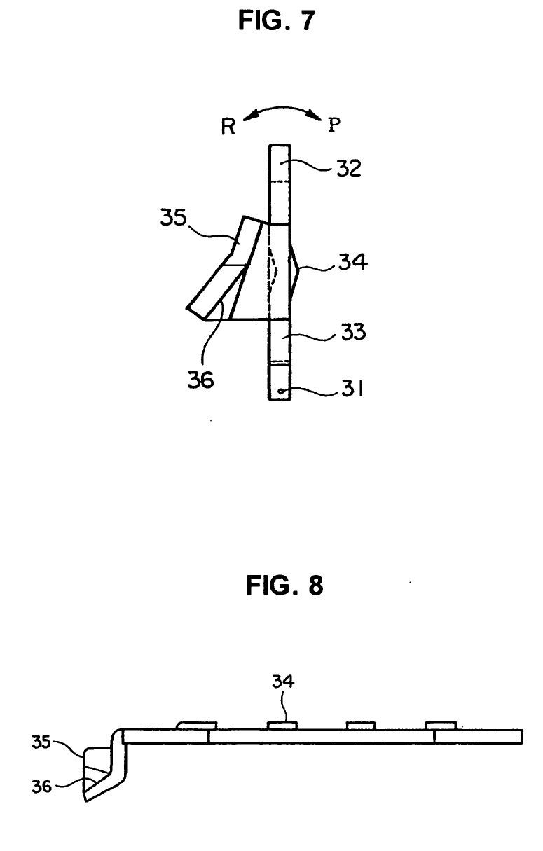

FIG. 6 is a plan view of a bolt 30 of the dial lock of the present invention, FIG. 7 is an end surface view when FIG. 6 is seen from the T direction, and FIG. 8 is a side surface view when FIG. 6 is seen from the S direction. A straight line 31 in the drawings illustrates a rotary axis of the bolt 30. Although a technology of a structure and an operation of the dial lock is well known, its outline will be described as follows in order to understand of the present invention. Reference code 33 denotes holes which the dials pass through, spacers rotating simultaneously with the dials are provided between the dials, and a recessed part is formed at one part of each of the spacers. Further, the bolt 30 has projected parts 34, which are engaged with the recessed parts, at respective positions opposing to the recessed parts of the spacers.

The bolt 30 is energized around the rotary axis 31 by elastic force in the P direction in FIG. 7. When the dials 21 are rotated (refer to FIGS. 1, 2, 4) and all recessed parts of the spacers meet with the projected parts 34 of the bolt 30, the projected parts 34 are engaged with the recessed parts of the spacers. Then, the bolt 30 is rotated in the P direction in FIG. 7 around the rotary axis 31. In the dial lock, when the bolt 30 is in a horizontal position, an end surface 32 at the opposing side of the rotary axis 31 controls the motion of a rod interlocking with the push levers 71 of the side locks 7 (refer to FIG. 1). Thus, even if the push levers 71 are pushed, they do not move and the dial lock is in the locked state.

When the dials 21 are rotated in accordance with a predetermined personal identification number so that the recessed parts of the spacers meet and engage with the projected parts 34 of the bolt 30, the bolt 30 is rotated in the P direction in FIG. 7 by elastic force as described above. Then, controlling of the rod interlocking with the push levers 71 is canceled, so that the lock is unlocked.

In addition to these normal structures, the bolt 30 of the dial lock of the present invention has a projected piece 35, which is formed as a driving part operated by a master key of an inspector, at an end thereof. Although the shape of the projected piece 35 is arbitrary, in an example of the drawings, the projected piece 35 has a pressing part 36 which is bent aslant. When an inspector recognizes necessity of opening a traveling bag and inspecting it after a passenger locks the dial lock of the traveling bag and checks-in it at a check-in counter, the inspector uses the master key which the inspector has beforehand. Then, the pressing part 36 of the projected piece 35 is pressed so as to rotate the bolt 30 in the R direction in FIG. 7 by a suitable structure. Then, the end surface 32 controlling the motion of the push levers 71 as described above is removed from the controlling position, so that the traveling bag can be opened by pushing the push levers (the rotating direction of the bolt 30 in this case is contrary to the rotating direction at the time of ordinary opening by arranging the positions of the recessed parts of the spacers in accordance with the personal identification number to rotate the bolt 30.).

When the inspector returns the key to an original position after the inspection and thereby pressing to the pressing part 36 is stopped, the bolt 30 is rotated in the P direction by elastic force, and the dial lock is returned to the locking state. As described about FIGS. 4 and 5, when the dial lock is unlocked by the master key, the key hole plate 51 is rotated, and the colored part 54 appears. Thus, it can be noticed at a glance that the dial lock is unlocked, so that the risk that the inspector forgets re-locking after the inspection can be prevented.

The dial lock for a traveling bag of the present invention can be unlocked by a master key, which only an inspector has, when it is authorized by the U.S. transportation security office. Thus, a passenger can check-in the locked traveling bag at the check-in counter as usual. Whenever the inspection is necessary, the inspector can freely unlock and re-lock the lock with the master key, so that breaking of the lock can be prevented.

What is claimed is:

1. A dial lock for a traveling bag, wherein a means for rotating a bolt of the dial lock between a locking position and unlocking position of a lock is provided in addition to a function of the dial lock.

2. The dial lock for a traveling bag as claimed in claim 1, wherein the rotary means provided at each traveling bag is a rotary body capable of being rotated by a common key.

3. The dial lock for a traveling bag as claimed in claim 1, wherein a rotary plate having a key hole for the common key is formed to have an oval-like shape obtained by cutting off both sides of a disk shape.
